(19) United States
(12) Patent Application Publication
(10) Pub. No.: US 2026/0040272 A1
(43) Pub. Date: Feb. 5, 2026

(54) COMMUNICATIONS LOCATION DERIVATION WHEN ON THE MOVE

(71) Applicant: Kymeta Corporation, Redmond, WA (US)

(72) Inventors: Rebecca B. Thompson, Redmond, WA (US); Alex Schnedler, Redmond, WA (US); Paul Klassen, Redmond, WA (US); Nick McCarty, Redmond, WA (US)

(21) Appl. No.: 19/285,883

(22) Filed: Jul. 30, 2025

Related U.S. Application Data
(60) Provisional application No. 63/677,905, filed on Jul. 31, 2024.

(51) Int. Cl. H04W 64/00

(52) U.S. Cl. CPC H04W 64/006

(57) ABSTRACT

A position, navigation, and timing (PNT) system, a satellite terminal and methods for using the same are disclosed. In some embodiments, a satellite terminal includes an antenna aperture and a computing device. The computing device is operable to execute an inversion algorithm to derive a location of the satellite terminal. This can be used when an external reference to its location is not available. The satellite terminal also includes a transcoder to create a transcoded signal using the location and a modem communicably coupled to the transcoder and the antenna aperture to receive the transcoded signal.

### RELATED APPLICATION

The present application is a non-provisional application of and claims the benefit of U.S. Provisional Patent Application No. 63/677,905, filed Jul. 31, 2024, and entitled “COMMUNICATIONS LOCATION DERIVATION WHEN ON THE MOVE”, which is incorporated by reference in its entirety.

### FIELD OF THE DISCLOSURE

Embodiments of the present disclosure are related to wireless communication; more particularly, embodiments disclosed herein related to a satellite device (e.g., terminal) configured to derive its location when an externally-provided location information is not available (e.g., Global Navigation Satellite System (GNSS) signals are not available) or accuracy of such a location is to be improved.

### BACKGROUND

Position, velocity, and timing signals from a Global Positioning System (GPS) are used throughout the world. GPS often relies on the use of Global Navigation Satellite System (GNSS) signals. The GNSS signals are received by a receiver and then used to generate the position, velocity and timing signals. However, a receiver cannot provide those signals if the GNSS signals are not available to the receiver. The GNSS signals may not be available due to interference (e.g., jamming), spoofing, or signal blockage. This situation is often referred to as a GNSS denial situation or a GNSS degraded situation.

GNSS signals can undergo interference due to jamming. Jamming occurs if a non-GNSS signal is intentionally transmitted in the GNSS frequency range. In such a case, the interfering signal essentially overpowers the GNSS signal, resulting in the inability of the GNSS receiver to compute a 2D or 3D geolocation fix. Spoofing is another form of interference, but, unlike the jamming scenario where a 2D or 3D geolocation fix cannot be computed, spoofing causes a receiver to report an incorrect location or time. In the GNSS context, spoofing can occur by broadcasting a signal with the same structure and frequency as the GNSS signal, thereby causing the receiver to lock onto the spoofed signal instead of the actual GNSS signal. The information in the spoofed signal is changed from that of the GNSS signal so that the receiver calculates an incorrect position or time. The most common form of GNSS signal degradation happens when a GNSS receiver is physically obstructed (e.g., buildings, mountains, trees, etc.) from receiving a GNSS signal. If any of the above situations occurs, then a GNSS denial situation or a GNSS degraded situation can exist.

### SUMMARY

A position, navigation, and timing (PNT) system, a satellite terminal and methods for using the same are disclosed. In some embodiments, a satellite terminal includes an antenna aperture and a computing device. The computing device is operable to execute an inversion algorithm to derive a location of the satellite terminal. This can be used when an external reference to its location is not available. The satellite terminal also includes a transcoder to create a transcoded signal using the location and a modem communicably coupled to the transcoder and the antenna aperture to receive the transcoded signal.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates an exploded view of some embodiments of a flat-panel antenna.

FIG. 2 illustrates an example of a communication system that includes one or more antennas according to some embodiments.

FIG. 3A illustrates a communication system in which a satellite antenna for a terminal derives position and holdover timing when position and location timing are missing because a GNSS signal from the GNSS network of constellations is not available (or any other location services for providing the location).

FIG. 3B illustrates a portion of some embodiments of a satellite terminal having an assured position, navigation, and timing (A-PNT) system.

FIG. 4 is a data flow diagram of some embodiments of a process for communicating with a satellite.

FIG. 5 is a data flow diagram of some embodiments of a process for deriving the location of the satellite terminal.

FIG. 6A is a data flow diagram of some other embodiments of a process for communicating with a satellite.

FIG. 6B illustrates some other embodiments of a process for deriving the location of the satellite terminal.

### DETAILED DESCRIPTION

In the following description, numerous details are set forth to provide a more thorough explanation of embodiments of the present disclosure. It will be apparent, however, to one skilled in the art, that the teachings disclosed herein may be practiced without these specific details. In other instances, well-known structures and devices are shown in block diagram form, rather than in detail, in order to avoid obscuring the present disclosure.

Techniques to derive a location (e.g., latitude/longitude/altitude) based on a satellite terminal antenna's acquisition and tracking system without global navigation satellite system (GNSS) information are disclosed herein. Techniques are also disclosed herein for an Assured-Positioning, Navigation, & Timing (A-PNT) system to use a derived location (e.g., latitude/longitude/altitude) to transcode to any GNSS-like source outputs (e.g., L1, L2, L5, etc.). Furthermore, techniques are also disclosed herein to use the derived location (e.g., latitude/longitude/altitude) to provide communications on the move (COTM) when there is no external location to reference and while the satellite terminal antenna is moving (e.g., while the vehicle or vessel to which it is coupled is moving, etc.). That is, techniques are also disclosed herein to use the derived location (e.g., latitude/longitude/altitude) to provide communications on the move when not receiving any location information from GNSS, STL (Satellite Time and Location), or other location services outside the derived location. Such techniques are very helpful for use with networks, such as, for example, the OneWeb Network, which cannot operate without a precise latitude, longitude, altitude, and time.

Additional details about these techniques are disclosed below.

### Examples of Antenna Embodiments

The techniques described herein may be used with a variety of flat panel satellite antennas. Embodiments of such flat panel antennas are disclosed herein. In some embodiments, the flat panel satellite antennas are part of a satellite terminal. The flat panel antennas include one or more arrays of antenna elements on an antenna aperture.

In some embodiments, the antenna aperture is a metasurface antenna aperture, such as, for example, the antenna apertures described below. In some embodiments, the antenna elements comprise radio-frequency (RF) radiating antenna elements. In some embodiments, the antenna elements include tunable devices to tune the antenna elements. Examples of such tunable devices include diodes and varactors such as, for example, described in U.S. Patent Application Publication No. 20210050671, entitled “Metasurface Antennas Manufactured with Mass Transfer Technologies,” published Feb. 18, 2021. In some other embodiments, the antenna elements comprise liquid crystal (LC)-based antenna elements, such as, for example, those disclosed in U.S. Pat. No. 9,887,456, entitled “Dynamic Polarization and Coupling Control from a Steerable Cylindrically Fed Holographic Antenna”, issued Feb. 6, 2018, or other RF radiating antenna elements. It should be appreciated that other tunable devices such as, for example, but not limited to, tunable capacitors, tunable capacitance dies, packaged dies, micro-electromechanical systems (MEMS) devices, or other tunable capacitance devices, could be placed into an antenna aperture or elsewhere in variations on the embodiments described herein.

In some embodiments, the antenna aperture has one or more arrays of antenna elements that are comprised of multiple segments that are coupled together. In some embodiments, when coupled together, the combination of the segments form groups of antenna elements (e.g., closed concentric rings of antenna elements concentric with respect to the antenna feed, etc.). For more information on antenna segments, see U.S. Pat. No. 9,887,455, entitled “Aperture Segmentation of a Cylindrical Feed Antenna”, issued Feb. 6, 2018.

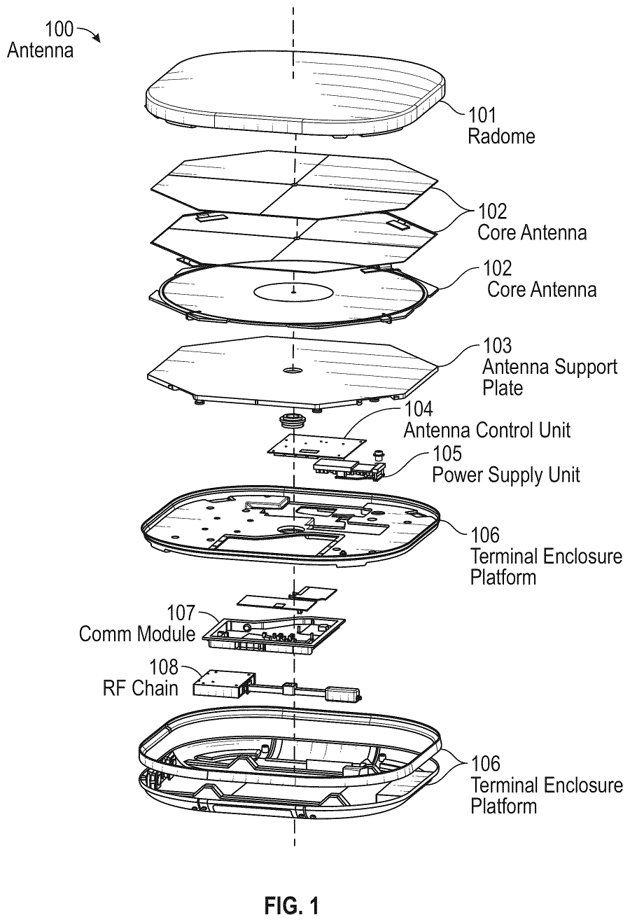

FIG. 1 illustrates an exploded view of some embodiments of a flat-panel antenna. Referring to FIG. 1, antenna 100 comprises a radome 101, a core antenna 102, antenna support plate 103, antenna control unit (ACU) 104, a power supply unit 105, terminal enclosure platform 106, comm (communication) module 107, and RF chain 108.

Radome 101 is the top portion of an enclosure that encloses core antenna 102. In some embodiments, radome 101 is weatherproof and is constructed of material transparent to radio waves to enable beams generated by core antenna 102 to extend to the exterior of radome 101.

In some embodiments, core antenna 102 comprises an aperture having RF radiating antenna elements. These antenna elements act as radiators (or slot radiators). In some embodiments, the antenna elements comprise scattering metamaterial antenna elements. In some embodiments, the antenna elements comprise both Receive (Rx) and Transmit (Tx) irises, or slots, that are interleaved and distributed on the whole surface of the antenna aperture of core antenna 102. Such Rx and Tx irises may be in groups of two or more sets where each set is for a separately and simultaneously controlled band. Examples of such antenna elements with irises are described in U.S. Pat. No. 10,892,553, entitled “Broad Tunable Bandwidth Radial Line Slot Antenna”, issued Jan. 12, 2021.

In some embodiments, the antenna elements comprise irises (iris openings) and the aperture antenna is used to generate a main beam shaped by using excitation from a cylindrical feed wave for radiating the iris openings through tunable elements (e.g., diodes, varactors, patch, etc.). In some embodiments, the antenna elements can be excited to radiate a horizontally or vertically polarized electric field at desired scan angles.

In some embodiments, a tunable element (e.g., diode, varactor, patch etc.) is located over each iris slot. The amount of radiated power from each antenna element is controlled by applying a voltage to the tunable element using a controller in ACU 104. Traces in core antenna 102 to each tunable element are used to provide the voltage to the tunable element. The voltage tunes or detunes the capacitance and thus the resonance frequency of individual elements to effectuate beam forming. The voltage required is dependent on the tunable element in use. Using this property, in some embodiments, the tunable element (e.g., diode, varactor, LC, etc.) integrates an on/off switch for the transmission of energy from a feed wave to the antenna element. When switched on, an antenna element emits an electromagnetic wave like an electrically small dipole antenna. Note that the teachings herein are not limited to having unit cell that operates in a binary fashion with respect to energy transmission. For example, in some embodiments in which varactors are the tunable element, there are 32 tuning levels. As another example, in some embodiments in which LC is the tunable element, there are 16 tuning levels.

A voltage between the tunable element and the slot can be modulated to tune the antenna element (e.g., the tunable resonator/slot). Adjusting the voltage varies the capacitance of a slot (e.g., the tunable resonator/slot). Accordingly, the reactance of a slot (e.g., the tunable resonator/slot) can be varied by changing the capacitance. Resonant frequency of the slot also changes according to the equation

$$f = \frac{1}{2 π \sqrt{LC}}$$

where f is the resonant frequency of the slot and L and C are the inductance and capacitance of the slot, respectively. The resonant frequency of the slot affects the energy coupled from a feed wave propagating through the waveguide to the antenna elements.

In particular, the generation of a focused beam by the metamaterial array of antenna elements can be explained by the phenomenon of constructive and destructive interference, which is well known in the art. Individual electromagnetic waves sum up (constructive interference) if they have the same phase when they meet in free space to create a beam, and waves cancel each other (destructive interference) if they are in opposite phase when they meet in free space. If the slots in core antenna 102 are positioned so that each successive slot is positioned at a different distance from the excitation point of the feed wave, the scattered wave from that antenna element will have a different phase than the scattered wave of the previous slot. In some embodiments, if the slots are spaced one quarter of a wavelength apart, each slot will scatter a wave with a one fourth phase delay from the previous slot. In some embodiments, by controlling which antenna elements are turned on or off (i.e., by changing the pattern of which antenna elements are turned on and which antenna elements are turned off) or which of the multiple tuning levels is used, a different pattern of constructive and destructive interference can be produced, and the antenna can change the direction of its beam(s).

In some embodiments, core antenna 102 includes a coaxial feed that is used to provide a cylindrical wave feed via an input feed, such as, for example, described in U.S. Pat. No. 9,887,456, entitled “Dynamic Polarization and Coupling Control from a Steerable Cylindrically Fed Holographic Antenna”, issued Feb. 6, 2018 or in U.S. Patent Application Publication No. 20210050671, entitled “Metasurface Antennas Manufactured with Mass Transfer Technologies,” published Feb. 18, 2021. In some embodiments, the cylindrical feed wave feeds core antenna 102 from a central point with an excitation that spreads outward in a cylindrical manner from the feed point. In other words, the cylindrically fed wave is an outward travelling concentric feed wave. Even so, the shape of the cylindrical feed antenna around the cylindrical feed can be circular, square or any shape. In some other embodiments, a cylindrically fed antenna aperture creates an inward travelling feed wave. In such a case, the feed wave most naturally comes from a circular structure.

In some embodiments, the core antenna comprises multiple layers. These layers include one or more substrate layers forming the RF radiating antenna elements. In some embodiments, these layers may also include impedance matching layers (e.g., a wide-angle impedance matching (WAIM) layer, etc.), one or more spacer layers and/or dielectric layers. Such layers are well-known in the art.

Antenna support plate 103 is coupled to core antenna 102 to provide support for core antenna 102. In some embodiments, antenna support plate 103 includes one or more waveguides and one or more antenna feeds to provide one or more feed waves to core antenna 102 for use by antenna elements of core antenna 102 to generate one or more beams.

ACU 104 is coupled to antenna support plate 103 and provides controls for antenna 100. In some embodiments, these controls include controls for drive electronics for antenna 100 and a matrix drive circuitry to control a switching array interspersed throughout the array of RF radiating antenna elements. In some embodiments, the matrix drive circuitry uses unique addresses to apply voltages onto the tunable elements of the antenna elements to drive each antenna element separately from the other antenna elements. In some embodiments, the drive electronics for ACU 104 comprise commercial off-the shelf LCD controls used in commercial television appliances that adjust the voltage for each antenna element.

More specifically, in some embodiments, ACU 104 supplies an array of voltage signals to the tunable devices of the antenna elements to create a modulation, or control, pattern. The control pattern causes the elements to be tuned to different states. In some embodiments, ACU 104 uses the control pattern to control which antenna elements are turned on or off (or which of the tuning levels is used) and at which phase and amplitude level at the frequency of operation. The elements are selectively detuned for frequency operation by voltage application. In some embodiments, multistate control is used in which various elements are turned on and off to varying levels, further approximating a sinusoidal control pattern, as opposed to a square wave (i.e., a sinusoid gray shade modulation pattern).

In some embodiments, ACU 104 also contains one or more processors executing the software to perform some of the control operations. ACU 104 may control one or more sensors (e.g., a GPS receiver, a three-axis compass, a 3-axis accelerometer, 3-axis gyro, 3-axis magnetometer, etc.) to provide location and orientation information to the processor(s). The location and orientation information may be provided to the processor(s) by other systems in the earth station and/or may not be part of the antenna system.

Antenna 100 also includes a comm (communication) module 107 and an RF chain 108. Comm module 107 includes one or more modems enabling antenna 100 to communicate with various satellites and/or cellular systems, in addition to a router that selects the appropriate network route based on metrics (e.g., quality of service (QoS) metrics, e.g., signal strength, latency, etc.). RF chain 108 converts analog RF signals to digital form. In some embodiments, RF chain 108 comprises electronic components that may include amplifiers, filters, mixers, attenuators, and detectors.

Antenna 100 also includes power supply unit 105 to provide power to various subsystems or parts of antenna 100.

Antenna 100 also includes terminal enclosure platform 106 that forms the enclosure for the bottom of antenna 100. In some embodiments, terminal enclosure platform 106 comprises multiple parts that are coupled to other parts of antenna 100, including radome 101, to enclose core antenna 102.

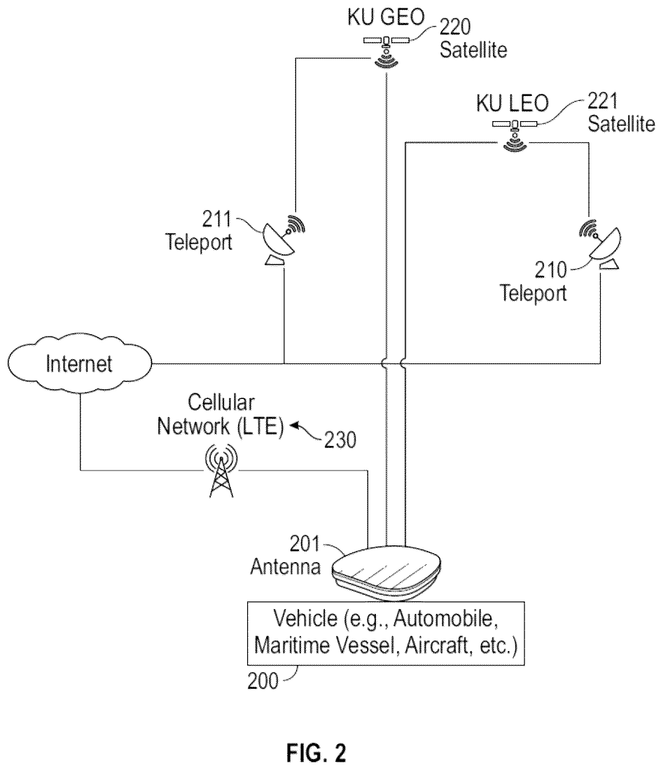

FIG. 2 illustrates an example of a communication system that includes one or more antennas described herein. Referring to FIG. 2, vehicle 200 includes an antenna 201. In some embodiments, antenna 201 comprises antenna 100 of FIG. 1. In some embodiments, vehicle 200 may comprise any one of several vehicles, such as, for example, but not limited to, an automobile (e.g., car, truck, bus, etc.), a maritime vehicle (e.g., boat, ship, etc.), airplanes (e.g., passenger jets, military jets, small craft planes, etc.), etc. Antenna 201 may be used to communicate while vehicle 200 is either on-the-pause, or moving. Antenna 201 may be used to communicate to fixed locations as well, e.g., remote industrial sites (mining, oil, and gas) and/or remote renewable energy sites (solar farms, windfarms, etc.).

In some embodiments, antenna 201 is able to communicate with one or more communication infrastructures (e.g., satellite, cellular, networks (e.g., the Internet), etc.). For example, in some embodiments, antenna 201 is able to communication with satellites 220 (e.g., a GEO satellite) and 221 (e.g., a LEO satellite), cellular network 230 (e.g., an LTE, etc.), as well as network infrastructures (e.g., edge routers, Internet, etc.). For example, in some embodiments, antenna 201 comprises one or more satellite modems (e.g., a GEO modem, a LEO modem, etc.) to enable communication with various satellites such as satellite 220 (e.g., a GEO satellite) and satellite 221 (e.g., a LEO satellite) and one or more cellular modems to communicate with cellular network 230. For another example of an antenna communicating with one or more communication infrastructures, see U.S. patent Ser. No. 16/750,439, entitled “Multiple Aspects of Communication in a Diverse Communication Network”, and filed Jan. 23, 2020.

In some embodiments, to facilitate communication with various satellites, antenna 201 performs dynamic beam steering. In such a case, antenna 201 is able to dynamically change the direction of a beam that it generates to facilitate communication with different satellites. In some embodiments, antenna 201 includes multi-beam beam steering that allows antenna 201 to generate two or more beams at the same time, thereby enabling antenna 201 to communicate with more than one satellite at the same time. Such functionality is often used when switching between satellites (e.g., performing a handover). For example, in some embodiments, antenna 201 generates and uses a first beam for communicating with satellite 220 and generates a second beam simultaneously to establish communication with satellite 221. After establishing communication with satellite 221, antenna 201 stops generating the first beam to end communication with satellite 220 while switching over to communicate with satellite 221 using the second beam. For more information on multi-beam communication, see U.S. Pat. No. 11,063,661, entitled “Beam Splitting Hand Off Systems Architecture”, issued Jul. 13, 2021.

In some embodiments, antenna 201 uses path diversity to enable a communication session that is occurring with one communication path (e.g., satellite, cellular, etc.) to continue during and after a handover with another communication path (e.g., a different satellite, a different cellular system, etc.). For example, if antenna 201 is in communication with satellite 220 and switches to satellite 221 by dynamically changing its beam direction, its session with satellite 220 is combined with the session occurring with satellite 221. In some embodiments, teleports 210 and 211 provide interconnections between satellites 221 and 220, respectively, to ground-based communications, such as cellular network 230, via a network such as, for example the Internet.

Thus, the antennas described herein may be part of a satellite terminal that enables ubiquitous communications and multiple different communication connections.

### Comms-On-the-Move Acquisition and Tracking in Holdover Timing Mode

In some embodiments, an inversion algorithm leverages complementary embedded sensors in conjunction with the communication satellite location and tracking over time (communication satellite location updates) to compute and/or derive the antenna/terminal location, without the GNSS network of constellations. In some embodiments, the inversion algorithm determines an antenna/terminal location while being mobile and tracking a communication satellite. In some embodiments, this determination is made using a computing device embedded in a satellite antenna of a satellite terminal. In some embodiments, the computing device is in the satellite terminal of which the satellite antenna is part.

More specifically, techniques disclosed herein leverage complementary sensors (e.g., IMU comprised of gyros & accelerometers, Inertial Navigation Systems (INS), etc.) embedded in a satellite antenna of a satellite terminal in concert with a satellite data link to perform an inversion operation to determine the physical location of the satellite antenna. In the absence of GNSS information, the complementary sensors are leveraged to determine the mobile platform's orientation and dynamics over time, such as angular acceleration and velocity that is indicative of a body turning, linear acceleration and velocity, and the specific axes that are detecting these dynamics. This type of position, orientation, and mobility detection relative to a body's starting point, in the absence of GNSS, is referred to as dead reckoning (DR). Dead reckoning on its own is error prone and, in a short period of time, the derived position solution can diverge significantly from ground truth. However, when DR is used in concert with a known satellite location and satellite signal, the solution is less likely to diverge from ground truth. In some embodiments, an ephemeris input is used as part of the location derivation process, providing the known satellite location to help constrain the geolocation inversion algorithm.

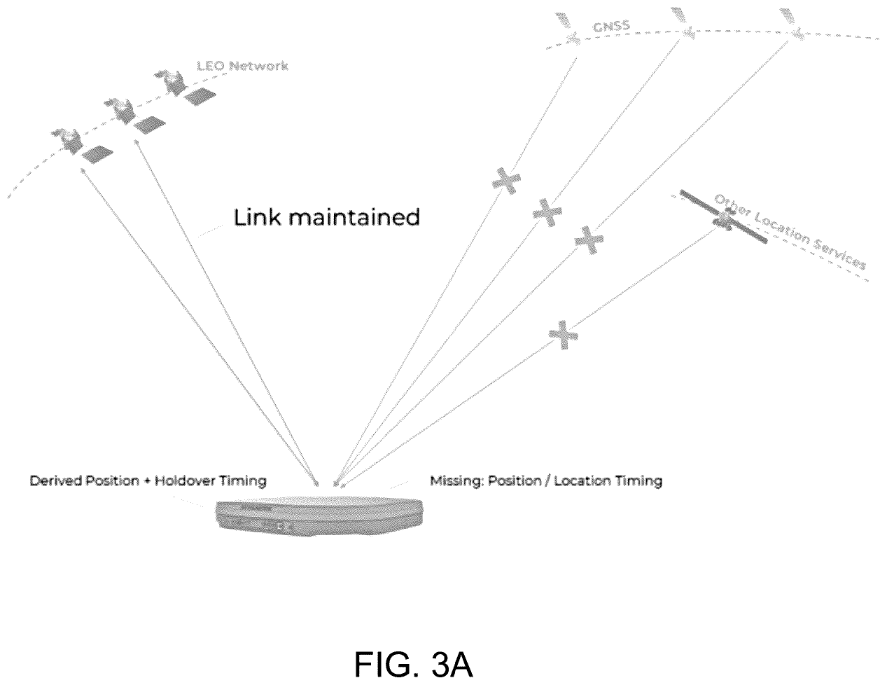

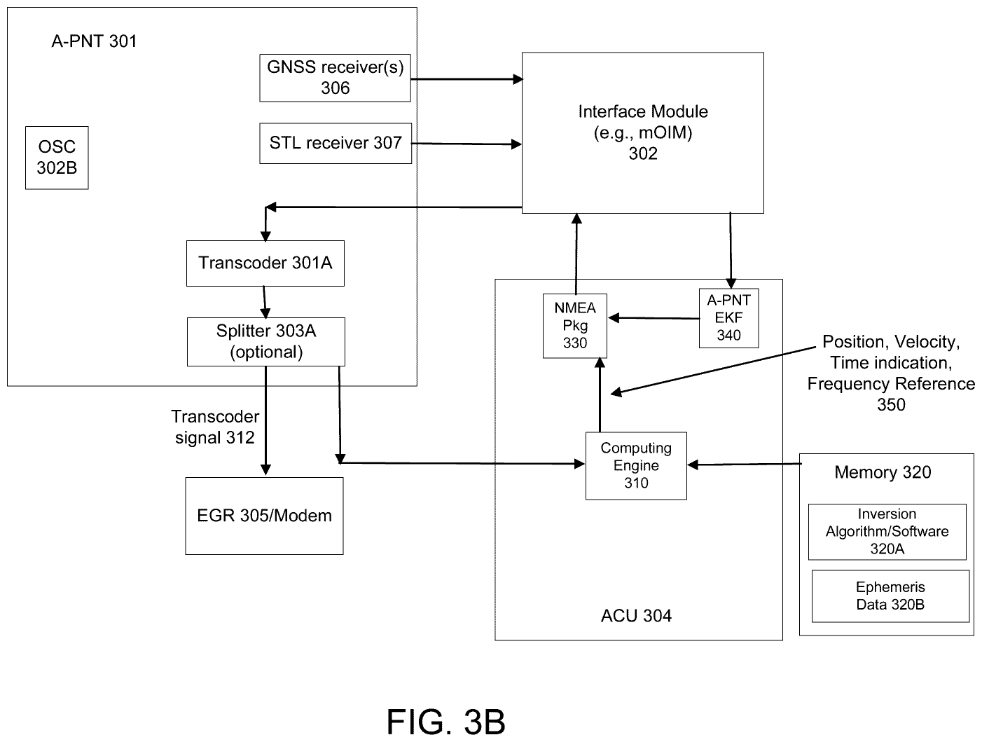

The derived location is then provided to an A-PNT device and/or algorithm that creates a transcoded L1, L2 or L5 signal replicating a GNSS signal to drive the embedded GNSS receivers of the satellite terminal. In other words, the derived location is provided as feedback to the transcoder, or the GNSS transcoder, which helps to drive the modem (e.g., a OneWeb modem) in the absence of an over-the-air GNSS signal from which a terminal location would otherwise be computed. Note that this could occur in a jammed environment where a GNSS signal cannot be obtained, such that a location and time is not available and an A-PNT device goes into holdover mode (which means it has the last location that the GNSS signal gave it while in synchronization, and has a well-disciplined, high stability oscillator (e.g., FIG. 3B OSC 302B) to continue to derive time). FIG. 3A illustrates such a situation where a satellite antenna for a terminal derives position and holdover timing when position and time are unavailable because a GNSS signal from the GNSS network of constellations is not available (nor are any other location services for providing the location).

This capability for generating the derived location is leveraged for static and mobile applications. For mobile applications, the location inversion algorithm is exercised at a predefined rate and the updated location is passed to the A-PNT device or algorithm at this rate, thereby updating the transcoded L1, L2, or L5 signal created to drive the embedded GNSS receivers. Thus, in some embodiments, the techniques disclosed herein enable the ability to communicate, at a regular rate, the computed mobile terminal location to an A-PNT device and/or algorithm that creates a transcoded L1, L2 or L5 signal replicating a GNSS signal to drive the embedded GNSS receivers.

FIG. 3B illustrates a portion of a satellite terminal having an A-PNT system, referred to as a PNT solution. Referring to FIG. 3B, a portion of the satellite terminal is shown having an A-PNT system 301, an interface module 302 (e.g., a military OneWeb Interface Module (mOIM), etc.), an ACU 304, and a modem support module, referred to as EGR 305. In some other embodiments, the interface module 302 can be part of ACU 304.

In some embodiments, the A-PNT system 301 includes a substrate (e.g., a PCB board) with multi-constellation receiver support and holdover capability that contributes position and timing to a modem support module (e.g., an EGR (External GNSS Receiver) and an antenna control unit (ACU) of the satellite terminal. In some embodiments, during normal operating mode, this substrate receives GNSS RF signals using one or more GNSS receivers. In some embodiments, A-PNT system 301 includes multiple receivers. In some embodiments, A-PNT system 301 includes a first receiver that detects if a signal becomes degraded or if the signal is no longer being received and a second receiver (e.g., a Satellite Time and Location (STL) receiver).

In some embodiments, A-PNT system 301 includes one or more GNSS receivers (with associated antenna) 306 and a Satellite Time and Location (STL) receiver 307. In some other embodiments, GNSS receiver(s) 306 and STL receiver 307 are separate from A-PNT system 301. GNSS receiver(s) 306 and STL receiver 307 receive signals and compute measurements from constellation signals (e.g., GNSS signals and an STL signal) which are then delivered to the interface module 302 as raw observables. In some embodiments, the GNSS and STL measurements from their respective receivers go to an onboard EKF 340 for geolocation via sensor fusion techniques.

In some embodiments, position and navigation constellation signals could come from GNSS constellations comprising, for example, but not limited to: GPS (US MEO), BEIDOU (China), GALILEO (EU), and GLONASS (Russia), as well as Satelles (Iridium LEO) and Mosaic (Inmarsat GEO), and a backup oscillator comprising of either OCXO, Rubidium, or Cesium clocks.

In some embodiments, during normal operation, the receivers of A-PNT system 301 provide a primary reference source (PRS) output (e.g., a Layer 1 (L1) signal output, a Layer 5 (L5) signal output, etc.) to onboard position and timing signal transcoder 301A. In some embodiments, A-PNT 301 in conjunction with the stacked ranking of the A-PNT capabilities, determines which to use as the transcoder input (e.g., which is the best choice signal for the transcoder). This determination can be based on whether the onboard receiver signals stop or are denied (e.g., the interference from jamming and/or whether spoofing is occurring).

Thus, in response to GNSS signal(s) and STL signals, A-PNT system 301, via use of an onboard position and timing signal transcoder 301A, outputs the reference signal (transcoded output signal 312) to EGR 305 (e.g., LEO modem and GNSS receiver) and the onboard position and timing system in or coupled to ACU 304 (e.g., the ACU modem and GNSS receiver). In some embodiments, A-PNT system 301 sends this transcoder L1 output 312 to the embedded GPS receiver (EGR 305) for LEO modem support and the ACU 304 for LEO and GEO mode support. The timing and location information in the transcoded signal is required for satellite communication in a manner well-known in the art.

In some embodiments, A-PNT 301 includes a splitter 303A to create two signals from transcoder output signal 312 to both EGR 305 and ACU 304 (e.g., to computing engine 310). Alternatively, splitter 303A can be outside of A-PNT 301 between A-PNT 301 and both EGR 305 and ACU 304.

In some embodiments, ACU 304 provides position information to be used by transcoder 301A while the terminal is in holdover mode (e.g., GNSS denied). This can occur when the satellite terminal is in holdover mode. For example, if GNSS receiver(s) 306 and STL receiver 307 are jammed, blocked, spoofed, or degraded, then ACU 304 provides information to the transcoder 301A to enable satellite terminal to continue to engage in satellite communication. Also, if the onboard receiver signals from GNSS receiver(s) 306 and STL receiver 307 stop or are denied, the backup oscillator 302B provides timing to A-PNT system 301 (and other terminal components) to facilitate on-going satellite communication. In this way, the satellite terminal can handle communications, including communications on the pause/halt (COTP/COTH) or communications on the move (COTM) during holdover.

In some embodiments, during holdover, ACU 304 provides information that is created and sent to interface module 302 and forwarded to transcoder 301A. Note that in other embodiments, ACU 304 sends the information directly to transcoder 301A or directly to A-PNT 301, which provides it to transcoder 301A.

In some embodiments, the ACU 304 sends the computed geolocation information to A-PNT 301 using the NMEA package 330. In some embodiments, the geolocation information is created by computing engine 310 (e.g., hardware (e.g., one or more processors, circuitry, dedicated logic, etc.), software, firmware, or a combination of the three). In some embodiments, computing engine 310 derives the geolocation information using an inversion algorithm (e.g., software) 320A and ephemeris data 320B that are stored in a memory 320 of the terminal. In some embodiments, the information sent by computing engine 310 includes position of the terminal, velocity of the terminal, a time indication, and a frequency reference (350). In some embodiments, the information 350 provided to the transcoder 301A includes position of the satellite terminal (e.g., longitude and latitude of the satellite terminal, etc.), velocity of the satellite terminal or similar indication (e.g., speed of the satellite terminal, etc.), and time (e.g., GPS time, Coordinated Universal Time (UTC), pulse per second (PPS)). In some embodiments, the frequency reference is provided by a disciplined oscillator 302B (disciplined by either the GNSS signals captured by GNSS receiver(s) 306 or the STL signal from STL receiver 307 prior to them becoming unavailable) that is part of A-PNT 301. In response to this information 350, transcoder 301A is able to generate the transcoder output signal 312 while the A-PNT is in the holdover mode. With this information, the terminal has the ability to acquire and operate with certain satellite networks (e.g., the OneWeb network) while in holdover in the absence of GNSS and STL (e.g., Iridium STL), particularly in cases where the position of the satellite terminal is changing.

In some embodiments, ACU 304 determines the position and the velocity of the terminal. ACU 304 determines the position by geolocating itself. In some embodiments, ACU 304 determines the position using angle of arrival (or, phase difference of arrival which results in a line-of-bearing) and/or frequency difference of arrival (or frequency of arrival measurements) or one or more observations from other points. The observation points are in relative motion with respect to each other and the terminal, and the relative motion results in different doppler shifts observations of the terminal at each location in general. The location of the terminal can then be estimated with knowledge of the observation points' location and vector velocities and the observed relative doppler shifts between pairs of locations.

In some embodiments, ACU 304 uses ephemeris files (e.g., ephemeris data 320B) to compute an Earth-centered Earth-fixed (ECEF) location of the satellite and then inverts that position to determine the position of the terminal. In some embodiments, the ephemeris files are obtained from the network provider (e.g., OneWeb network) and preloaded onto the modem of the satellite terminal at the time of manufacturing. In some other embodiments, the ephemeris files are downloaded to the modem (e.g., downloaded while the terminal is in the field).

In some embodiments, ACU 304 obtains velocity data from the vehicle or vessel (not shown) to which the terminal is coupled. In some embodiments, the velocity data that is used for the transcoder signal generation is the speed (e.g., 3D speed) of the vehicle or vessel. For example, in some embodiments, to obtain the speed, the terminal has an on-board diagnostic system such as, for example, but not limited to, an OBD2 (On-Board Diagnostics II) system that measures vehicle speed by accessing data from the vehicle's speed sensor, which is typically mounted on the transmission.

In some embodiments, ACU 304 obtains the PPS from an oscillator on the A-PNT 301. This can be performed in a manner well-known in the art. Note that once this is disciplined it will continue to provide a good PPS and frequency reference without any GNSS or STL information (so, in holdover mode).

Thus, ACU 304 fuses the position, velocity, time and frequency reference into one package (e.g., NMEA package 330) and feeds this information to transcoder 301A (via interface module 302) to allow transcoder 301A to continue to output a transcoder signal to drive the downstream receivers of the terminal. That is, in response to this information, transcoder 301A is able to generate transcoder signal 312 in the same way as if GNSS signals captured by GNSS receiver(s) 306, the STL signal from STL receiver 307, or some other external signal with location information had been available. The transcoder 301A drives the EGR 305, which is then responsible for delivering its PPS and frequency reference to the modem and RF chain.

Integration of the fully GNSS denied solution in both long and short holdover (for long and short outages, respectively) with highly precise timing into a multi-network and multi-constellation user terminal enables high availability communications across the network without loss of connection due to loss of position and time synchronization.

Using the techniques described here enables comms-on-the-move regardless of A-PNT algorithm/device status—GNSS mode, STL mode, holdover mode, etc. Furthermore, when in holdover (oscillator is no longer disciplined by external time source), existing solutions only support static applications, and in such situations, these techniques to derive the new location without GNSS and provide it to a transcoder at regular intervals will enable mobility while in holdover.

Note that while OneWeb and the OneWeb modem have been mentioned, the techniques disclosed herein are applicable to terminals with modems for other networks (e.g., Starlink) where ephemeris information could be used to calculate a precise terminal location.

Note that the techniques can be used in conjunction with Chip Scale Atomic Clock (CSAC) or Microelectromechanical system (MEMs) oscillators on a Printed Circuit Board Assembly (PCBA) of a satellite antenna of a satellite terminal with custom or off-the-shelf transcoder hardware, firmware and/or software. Furthermore, the techniques can be implemented in any devices connected or housed within or externally attached to the satellite communication terminal that send and receive data requiring location data while no external location sources are available.

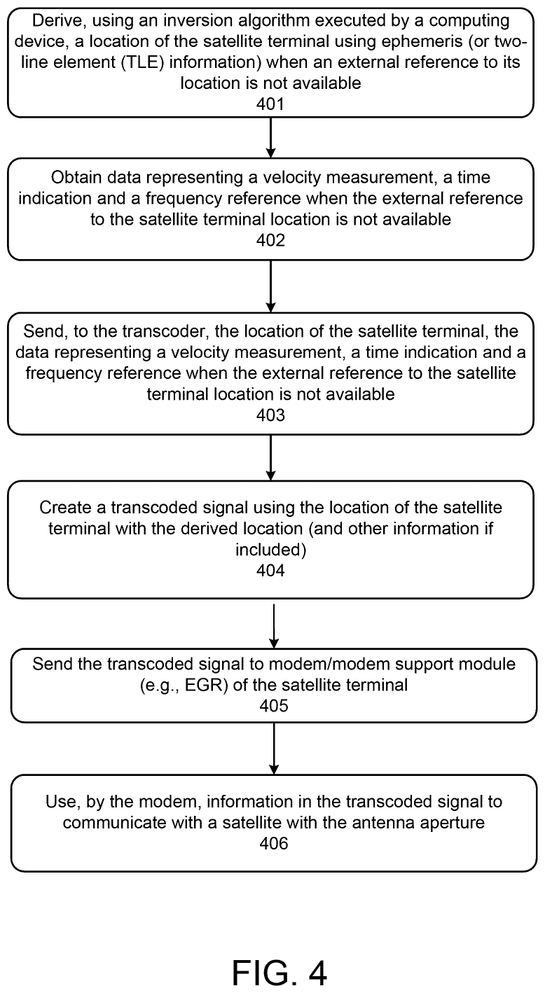

FIG. 4 is a data flow diagram of some embodiments of a process for communicating with a satellite. In some embodiments, the process is implemented by processing logic comprising hardware (e.g., circuitry, dedicated logic, etc.), software (e.g., software running on a chip, software run on a general-purpose computer system or a dedicated machine, etc.), firmware, or a combination of the three. In some embodiments, the process is performed by a satellite terminal, such as, for example, the satellite terminal described above, that includes an antenna control unit (ACU), a computing engine/device, an A-PNT, a transcoder, a modem, and one or more receivers (e.g., one or more GNSS receivers). In some embodiments, the modem is a OneWeb modem, though this is not required for use of the techniques herein.

Referring to FIG. 4, the process includes deriving, using an inversion algorithm executed by a computing device, a location of the satellite terminal when an external reference to its location is not available (processing block 401). In some embodiments, a computing device/engine (e.g., processor, etc.) of the satellite terminal derives the location of the satellite terminal. In some embodiments, the computing device is part of the ACU of the satellite terminal. However, the computing device can be outside of the ACU.

In some embodiments, deriving the location of the satellite terminal is performed when the A-PNT is operating in holdover mode. In some other embodiments, deriving the location is performed using ephemeris or two-line element (TLE) information stored on the satellite terminal and occurs while the antenna aperture is moving and tracking the satellite and while not receiving location information from global navigation satellite system (GNSS). In some other embodiments, deriving the location is performed using both ephemeris or TLE information stored on the satellite terminal in addition to the raw measurements computed by the Satellite Time and Location (STL) receiver. In yet some other embodiments, deriving the location is performed while not receiving location information from a global navigation satellite system (GNSS), Satellite Time and Location (STL) systems, or other location providing services outside the derived location.

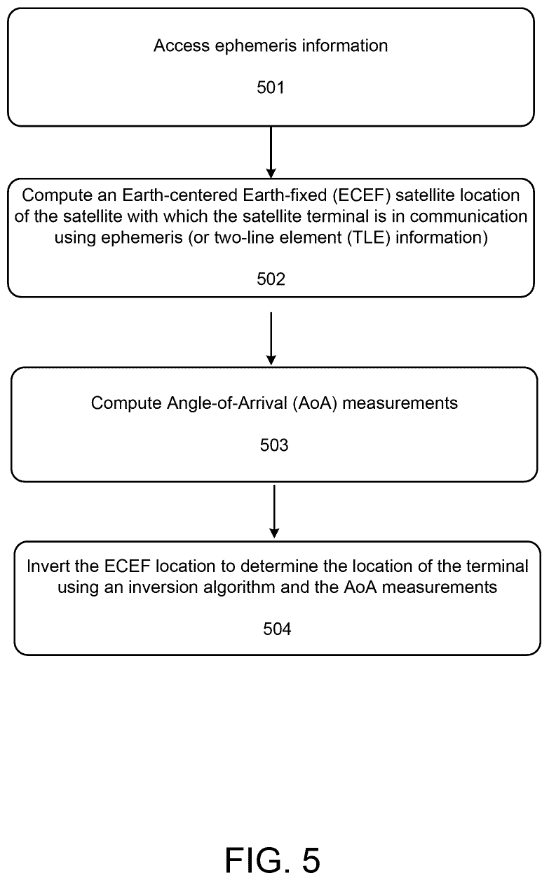

In some embodiments, deriving the location is performed using ephemeris information stored on the satellite terminal. FIG. 5 is a data flow diagram of some embodiments of a process for deriving the location of the satellite terminal. In some embodiments, the process is implemented by processing logic comprising hardware (e.g., circuitry, dedicated logic, etc.), software (e.g., software running on a chip, software run on a general-purpose computer system or a dedicated machine, etc.), firmware, or a combination of the three. In some embodiments, the process is performed by the ACU of a satellite terminal. In some other embodiments, the process is performed within the satellite terminal but outside of the ACU.

Referring to FIG. 5, the processing includes accessing ephemeris or TLE information (processing block 501). In some embodiments, the ephemeris or TLE information is associated with the satellite network (e.g., OneWeb Network) of the satellite with which the satellite terminal is communicating using its modem (e.g., a OneWeb modem). In some embodiments, the ephemeris or TLE information is accessed by a computing device of the satellite terminal from a memory on the satellite terminal. In some other embodiments, the ephemeris or TLE information is accessed by downloading the ephemeris or TLE information to the satellite terminal and thereafter is stored in a memory on the satellite terminal.

Using the ephemeris or TLE information, the process computes a precise Earth-centered Earth-fixed (ECEF) location of the satellite with which the satellite terminal may or may not be connected for data communication, but the satellite can be employed in either instance for geolocation and velocity computation purposes (processing block 502). Knowing the precise location of the satellite, the precise time, and using this information in conjunction with antenna elements (e.g., RF radiating antenna elements) of an antenna array (like those on the metasurface), the process computes an Angle of Arrival (AoA, also known as Direction Finding (DF)) measurement (processing block 503). This AoA can then be used to project a line of bearing (LOB) between the source and the receiver. The intersection of multiple LOB measurements over time may be combined to compute a geolocation, which is one way the satellite terminal uses the satellite ECEF location to determine the location of the terminal using an inversion algorithm (processing block 504).

In addition to AoA measurements, the algorithm may also take advantage of the frequency difference of arrival (FDOA) measurements, more commonly referred to as Doppler measurements, to invert for a satellite terminal location and velocity. FDOA computation requires precise knowledge of the satellite location and velocity (ECEF over time computed from ephemeris or TLE), satellite transmission frequency, satellite terminal receiver frequency, and satellite terminal orientation at a given point in time. In some embodiments, from this information computed at multiple points in time and space, the process computes a geolocation in addition to a velocity of the satellite terminal. The AoA and FDOA measurements may be leveraged on their own to compute a geolocation and velocity, or they may be fused with STL raw observables to further improve the accuracy of the computed geolocation and velocity.

AoA, FDOA, and STL measurements can be error prone, especially when relative geometry of the satellite(s) versus the satellite terminal is poor and/or when multipath is a significant factor (reflective surfaces are near the satellite communication terminal). Sensor fusion techniques can greatly reduce the measurement errors. To this end, the data from an IMU, INS, OBD-II and mapped elevation data (digital terrain elevation data (DTED), or digital terrain model (DTM) data) are fused via an extended Kalman filter (EKF) to improve the geolocation inversion algorithm accuracy. These data function to constrain the solution (remove degrees of freedom), remove erroneous data, and allow the solution to be computed even in scenarios with degraded geometry.

Referring back to FIG. 4, in some embodiments, the processes includes obtaining data representing a velocity measurement, a time indication and a frequency reference when the external reference to the satellite terminal location is not available (processing block 402) and sending, to the transcoder, the location of the satellite terminal, the data representing a velocity measurement, a time indication and a frequency reference when the external reference to the satellite terminal location is not available (processing block 403). In some embodiments, this information is sent as part of a single package (e.g., a NMEA package), though this is not required and each of these pieces of data can be sent separately or in sub-groups.

With the derived location, processing logic creates a transcoded signal using the location of the satellite terminal (processing block 404). In some embodiments, the transcoded signal is created by a transcoder. The transcoder can be part of an A-PNT system of the satellite terminal. In some embodiments, the transcoded signal is a transcoded L1, L2 or L5 signal. In some embodiments, processing logics creating the transcoded signal using the derived location of the satellite terminal, as well as a velocity measurement, and the time indication (e.g., GPS time, UTC time, and/or PPS, etc.) is sent with it to the transcoder.

Processing logic sends the transcoded signal to the modem of the satellite terminal, a modem support module (e.g., mOIM, an EGR, etc.) (processing block 405), and it may or may not send the transcoded signal to an ACU. The modem uses information in the transcoded signal to communicate with a satellite with the antenna aperture (processing block 406). In some embodiments, communicating with a satellite using the antenna aperture and the modem based on information in the transcoded signal includes driving the one or more embedded GNSS receivers of the satellite terminal using the transcoded signal.

In some embodiments, the techniques disclosed herein can be used during situations when the STL is no functioning well enough and the addition of AoA or FDOA would improve the accuracy of the location and/or velocity determinations. In some embodiments, the terminal of FIG. 3B determines the location and/or velocity using STL raw observables from the STL receiver of the terminal with the addition of AoA or FDOA information.

In some embodiments, the satellite terminal includes an antenna aperture having antenna elements, a computing engine/device, a transcoder, and a modem. The antenna aperture can comprise an aperture as described herein or other antenna apertures. In some embodiments, the computing device derives a location of the satellite terminal using an inversion algorithm and using ephemeris information (or two-line element (TLE) information) stored on the satellite terminal. The transcoder creates a transcoded signal using the location, and the modem, which is communicably coupled to the transcoder and the antenna aperture, receives and uses the transcoded signal to facilitate satellite communication.

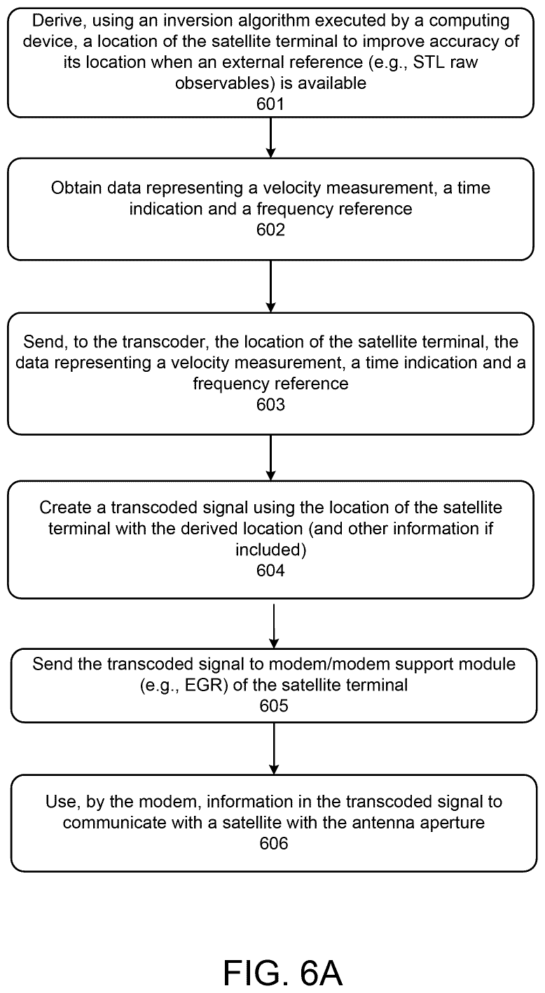

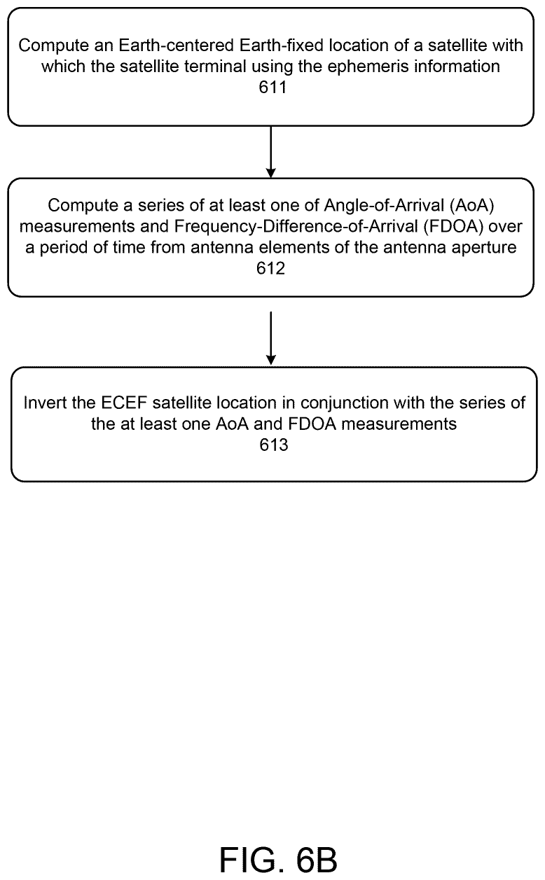

FIG. 6A is a data flow diagram of some other embodiments of a process for communicating with a satellite. In some embodiments, the process is implemented by processing logic comprising hardware (e.g., circuitry, dedicated logic, etc.), software (e.g., software running on a chip, software run on a general-purpose computer system or a dedicated machine, etc.), firmware, or a combination of the three. In some embodiments, the process is performed by a satellite terminal, such as, for example, the satellite terminal described above, that includes an antenna control unit (ACU), a computing engine/device, an A-PNT, a transcoder, a modem, and one or more receivers (e.g., one or more GNSS receivers). In some embodiments, the modem is a OneWeb modem, though this is not required for use of the techniques herein.

Referring to FIG. 6A, the process includes deriving, using an inversion algorithm executed by a computing device, a location of the satellite terminal to improve accuracy of its location when an external reference (e.g., STL raw observables) is available (processing block 601). In some embodiments, a computing device (e.g., processor, etc.) of the satellite terminal derives the location of the satellite terminal. In some embodiments, the computing device is part of the ACU of the satellite terminal. However, the computing device can be outside of the ACU.

In some embodiments, deriving the location of the satellite terminal is performed using ephemeris or two-line element (TLE) information stored on the satellite terminal and occurs while the antenna aperture is moving and tracking the satellite and while not receiving location information from global navigation satellite system (GNSS). In some other embodiments, deriving the location is performed using both ephemeris or TLE information stored on the satellite terminal in addition to the raw measurements computed by the Satellite Time and Location (STL) receiver.

Using the ephemeris or TLE information, the process computes a precise Earth-centered Earth-fixed (ECEF) location of the satellite with which the satellite terminal may or may not be connected for data communication, but the satellite can be employed in either instance for geolocation and velocity computation purposes. In some embodiments, knowing the precise location of the satellite, the precise time, and using this information in conjunction with antenna elements (e.g., RF radiating antenna elements) of an antenna array (like those on the metasurface), the process computes an Angle of Arrival (AoA, also known as Direction Finding (DF)) measurement. This AoA can then be used to project a line of bearing (LOB) between the source and the receiver. The intersection of multiple LOB measurements over time may be combined to compute a geolocation, which is one way the satellite terminal uses the satellite ECEF location to determine the location of the terminal using an inversion algorithm.

In addition to AoA measurements, the algorithm may also take advantage of the frequency difference of arrival (FDOA) measurements, more commonly referred to as Doppler measurements, to invert for a satellite terminal location and velocity. FDOA computation requires precise knowledge of the satellite location and velocity (ECEF over time computed from ephemeris or TLE), satellite transmission frequency, satellite terminal receiver frequency, and satellite terminal orientation at a given point in time. In some embodiments, from this information computed at multiple points in time and space, the process computes a geolocation in addition to a velocity of the satellite terminal. In some embodiments, the AoA and FDOA measurements are fused with STL raw observables to further improve the accuracy of the computed geolocation and velocity.

AoA, FDOA, and STL measurements can be error prone, especially when relative geometry of the satellite(s) versus the satellite terminal is poor and/or when multipath is a significant factor (reflective surfaces are near the satellite communication terminal). Sensor fusion techniques can greatly reduce the measurement errors. To this end, the data from an IMU, INS, OBD-II and mapped elevation data (digital terrain elevation data (DTED), or digital terrain model (DTM) data) are fused via an extended Kalman filter (EKF) to improve the geolocation inversion algorithm accuracy. These data function to constrain the solution (remove degrees of freedom), remove erroneous data, and allow the solution to be computed even in scenarios with degraded geometry.

In some embodiments, the processes include obtaining data representing a velocity measurement, a time indication and a frequency reference (processing block 602) and sending, to the transcoder, the location of the satellite terminal, the data representing a velocity measurement, a time indication and a frequency reference (processing block 603). In some embodiments, this information is sent as part of a single package (e.g., a NMEA package), though this is not required and each of these pieces of data can be sent separately or in sub-groups.

With the derived location, processing logic creates a transcoded signal using the location of the satellite terminal (processing block 604). In some embodiments, the transcoded signal is created by a transcoder. The transcoder can be part of an A-PNT system of the satellite terminal. In some embodiments, the transcoded signal is a transcoded L1, L2 or L5 signal. In some embodiments, processing logics creating the transcoded signal using the derived location of the satellite terminal, as well as a velocity measurement, and the time indication (e.g., GPS time, UTC time, and/or PPS, etc.) is sent with it to the transcoder.

Processing logic sends the transcoded signal to the modem of the satellite terminal, a modem support module (e.g., mOIM, an EGR, etc.) (processing block 605), and it may or may not send the transcoded signal to an ACU. The modem uses information in the transcoded signal to communicate with a satellite with the antenna aperture (processing block 606). In some embodiments, communicating with a satellite using the antenna aperture and the modem based on information in the transcoded signal includes driving the one or more embedded GNSS receivers of the satellite terminal using the transcoded signal.

FIG. 6B illustrates some embodiments of a process for deriving the location of the satellite terminal. In some embodiments, the process is performed by a computing device. In some embodiments, a computing device (e.g., processor, etc.) of the satellite terminal derives the location of the satellite terminal. In some embodiments, the computing device is part of the ACU of the satellite terminal. However, the computing device can be outside of the ACU.

Referring to FIG. 6B, the process includes computing an Earth-centered Earth-fixed location of a satellite with which the satellite terminal using the ephemeris information (processing block 611), computing a series of at least one of Angle-of-Arrival (AoA) measurements and Frequency-Difference-of-Arrival (FDOA) over a period of time from antenna elements of the antenna aperture (processing block 612), inverting the ECEF satellite location in conjunction with the series of the at least one AoA and FDOA measurements (processing block 613), and using the series of the at least one AoA and FDOA measurements with STL raw observables as part of obtaining at least one of the geolocation position and velocity of the terminal. In some embodiments, the result of the inversion adjusts and/or improves the accuracy of one or both of the geolocation position and velocity of the terminal.

There is a number of example embodiments described herein.

Example 1 is a satellite terminal including: an antenna aperture; a computing device to execute an inversion algorithm to derive a location of the satellite terminal; a transcoder to create a transcoded signal using the location; and a modem communicably coupled to the transcoder and the antenna aperture to receive the transcoded signal.

Example 2 is the satellite terminal of example 1 that may optionally include a modem support module operable to receive the transcoded signal from the transcoder.

Example 3 is the satellite terminal of example 1 that may optionally include that the computing device is operable to derive the location using ephemeris information stored on the satellite terminal when an external reference to its location is not available.

Example 4 is the satellite terminal of example 3 that may optionally include that the computing device is operable to compute an Earth-centered Earth-fixed location of a satellite with which the satellite terminal, using the ephemeris information and to compute a series of at least one of an Angle-of-Arrival (AoA) measurements, Frequency-of-Arrival (FOA) measurements, and Frequency-Difference-of-Arrival (FDOA) measurements across antenna elements of the antenna aperture, and then to use the ECEF satellite location in conjunction with the series of at least one AoA, FOA, and FDOA measurements over time to invert for the location of the terminal.

Example 5 is the satellite terminal of example 1 that may optionally include that the computing device is operable to derive the location using two-line element (TLE) information stored on the satellite terminal when an external reference to its location is not available.

Example 6 is the satellite terminal of example 1 that may optionally include that the computing device is operable to derive the location when the satellite terminal is operating in holdover mode.

Example 7 is the satellite terminal of example 1 that may optionally include that the computing device is operable to derive the location while the antenna aperture is moving and tracking a satellite and while not receiving location information from global navigation satellite system (GNSS).

Example 8 is the satellite terminal of example 7 that may optionally include that the computing device is operable to derive the location while not receiving location information from Satellite Time and Location (STL) or other location providing services outside the derived location.

Example 9 is the satellite terminal of example 1 that may optionally include that the transcoder is part of an assured positioning, navigation, and timing (A-PNT) system and the computing device is part of an antenna control unit.

Example 10 is the satellite terminal of example 1 that may optionally include one or more embedded GNSS receivers, and wherein the transcoded signal replicates a GNSS signal to drive the one or more embedded GNSS receivers.

Example 11 is the satellite terminal of example 1 that may optionally include that the modem is a OneWeb modem.

Example 12 is the satellite terminal of example 1 that may optionally include that the transcoded signal is a transcoded L1, L2 or L5 signal.

Example 13 is a method for use by a satellite terminal having an antenna aperture, a computing device, a transcoder and a modem, where the method includes: deriving, using an inversion algorithm executed by a computing device, a location of the satellite terminal when an external reference to its location is not available; creating, by the transcoder, a transcoded signal using the location of the satellite terminal; sending the transcoded signal to modem; and communicating with a satellite with the antenna aperture and the modem based on information in the transcoded signal.

Example 14 is the method of example 13 that may optionally include sending the transcoded signal to modem support module.

Example 15 is the method of example 13 that may optionally include that deriving the location is performed using ephemeris information stored on the satellite terminal.

Example 16 is the method of example 15 that may optionally include that deriving the location of the satellite terminal comprises: computing an Earth-centered Earth-fixed location of a satellite with which the satellite terminal using the ephemeris information; computing a series of at least one of Angle-of-Arrival (AoA) measurements and Frequency-Difference-of-Arrival (FDOA) over a period of time from antenna elements of the antenna aperture; and inverting the ECEF satellite location in conjunction with the series of the at least one of AoA measurements and FDOA measurements to determine the location of the terminal.

Example 17 is the method of example 13 that may optionally include that deriving the location of the satellite terminal is performed using ephemeris information stored on the satellite terminal occurs when the satellite terminal is operating in holdover mode.

Example 18 is the method of example 13 that may optionally include obtaining data representing a velocity measurement; and sending, to the transcoder, the location of the satellite terminal, the data representing a velocity measurement, a time indication and a frequency reference when the external reference to the satellite terminal location is not available, wherein creating the transcoded signal is based on the location of the satellite terminal, the data representing a velocity measurement, the time indication and the frequency reference.

Example 19 is the method of example 18 that may optionally include that the time indication comprises pulse per second.

Example 20 is the method of example 13 that may optionally include that deriving the location is performed using ephemeris information stored on the satellite terminal occurs while the antenna aperture is moving and tracking the satellite and while not receiving location information from global navigation satellite system (GNSS).

Example 21 is the method of example 13 that may optionally include that the satellite further comprises one or more embedded GNSS receivers, and wherein communicating with a satellite with the antenna aperture and the modem based on information in the transcoded signal comprises driving the one or more embedded GNSS receivers using the transcoded signal.

Example 22 is a satellite terminal including: an antenna aperture; a computing device to derive a location of the satellite terminal using an inversion algorithm and using ephemeris information stored on the satellite terminal; a transcoder to create a transcoded signal using the location; and a modem communicably coupled to the transcoder and the antenna aperture to receive the transcoded signal.

Example 23 is the satellite terminal of example 22 that may optionally include that the computing device is configured to: compute an Earth-centered Earth-fixed location of a satellite with which the satellite terminal using the ephemeris information; compute a series of at least one of Angle-of-Arrival (AoA) measurements and Frequency-Difference-of-Arrival (FDOA) over a period of time from antenna elements of the antenna aperture; and invert the ECEF satellite location in conjunction with the series of the at least one AoA and FDOA measurements and using the series of the at least one AoA and FDOA measurements with STL raw observables as part of obtaining at least one of the geolocation position and velocity of the terminal.

Methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

1. A satellite terminal comprising:
an antenna aperture;
a computing device to execute an inversion algorithm to derive a location of the satellite terminal;
a transcoder to create a transcoded signal using the location; and
a modem communicably coupled to the transcoder and the antenna aperture to receive the transcoded signal.

2. The satellite terminal of claim 1 further comprising
a modem support module operable to receive the transcoded signal from the transcoder.

3. The satellite terminal of claim 1 wherein the computing device is operable to derive the location using ephemeris information stored on the satellite terminal when an external reference to its location is not available.

4. The satellite terminal of claim 3 wherein the computing device is operable to compute an Earth-centered Earth-fixed location of a satellite with which the satellite terminal, using the ephemeris information and to compute a series of at least one of an Angle-of-Arrival (AoA) measurements, Frequency-of-Arrival (FOA) measurements, and Frequency-Difference-of-Arrival (FDOA) measurements across antenna elements of the antenna aperture, and then to use the ECEF satellite location in conjunction with the series of at least one AoA, FOA, and FDOA measurements over time to invert for the location of the terminal.

5. The satellite terminal of claim 1 wherein the computing device is operable to derive the location using two-line element (TLE) information stored on the satellite terminal when an external reference to its location is not available.

6. The satellite terminal of claim 1 wherein the computing device is operable to derive the location when the satellite terminal is operating in holdover mode.

7. The satellite terminal of claim 1 wherein the computing device is operable to derive the location while the antenna aperture is moving and tracking a satellite and while not receiving location information from global navigation satellite system (GNSS).

8. The satellite terminal of claim 7 wherein the computing device is operable to derive the location while not receiving location information from Satellite Time and Location (STL) or other location providing services outside the derived location.

9. The satellite terminal of claim 1 wherein the transcoder is part of an assured positioning, navigation, and timing (A-PNT) system and the computing device is part of an antenna control unit.

10. The satellite terminal of claim 1 further comprising one or more embedded GNSS receivers, and wherein the transcoded signal replicates a GNSS signal to drive the one or more embedded GNSS receivers.

11. The satellite terminal of claim 1 wherein the modem is a One Web modem.

12. The satellite terminal of claim 1 wherein the transcoded signal is a transcoded L1, L2 or L5 signal.

13. A method for use by a satellite terminal having an antenna aperture, a computing device, a transcoder and a modem, the method comprising:
deriving, using an inversion algorithm executed by a computing device, a location of the satellite terminal when an external reference to its location is not available;
creating, by the transcoder, a transcoded signal using the location of the satellite terminal;
sending the transcoded signal to modem; and
communicating with a satellite with the antenna aperture and the modem based on information in the transcoded signal.

14. The method of claim 13 further comprising:
sending the transcoded signal to modem support module.

15. The method of claim 13 wherein deriving the location is performed using ephemeris information stored on the satellite terminal.

16. The method of claim 15 wherein deriving the location of the satellite terminal comprises:
computing an Earth-centered Earth-fixed location of a satellite with which the satellite terminal using the ephemeris information; and
computing a series of at least one of Angle-of-Arrival (AoA) measurements and Frequency-Difference-of-Arrival (FDOA) over a period of time from antenna elements of the antenna aperture;
inverting the ECEF satellite location in conjunction with the series of the at least one of AoA measurements and FDOA measurements to determine the location of the terminal.

17. The method of claim 13 wherein deriving the location of the satellite terminal is performed using ephemeris information stored on the satellite terminal occurs when the satellite terminal is operating in holdover mode.

18. The method of claim 13 further comprising:
obtaining data representing a velocity measurement; and
sending, to the transcoder, the location of the satellite terminal, the data representing a velocity measurement, a time indication and a frequency reference when the external reference to the satellite terminal location is not available,
wherein creating the transcoded signal is based on the location of the satellite terminal, the data representing a velocity measurement, the time indication and the frequency reference.

19. The method of claim 18 wherein the time indication comprises pulse per second.

20. The method of claim 13 wherein deriving the location is performed using ephemeris information stored on the satellite terminal occurs while the antenna aperture is moving and tracking the satellite and while not receiving location information from global navigation satellite system (GNSS).

21. The method of claim 13 wherein the satellite further comprises one or more embedded GNSS receivers, and wherein communicating with a satellite with the antenna aperture and the modem based on information in the transcoded signal comprises driving the one or more embedded GNSS receivers using the transcoded signal.

22. A satellite terminal comprising:
an antenna aperture;
a computing device to derive a location of the satellite terminal using an inversion algorithm and using ephemeris information stored on the satellite terminal;
a transcoder to create a transcoded signal using the location; and
a modem communicably coupled to the transcoder and the antenna aperture to receive the transcoded signal.

23. The satellite terminal of claim 22 wherein the computing device is configured to:
compute an Earth-centered Earth-fixed location of a satellite with which the satellite terminal using the ephemeris information;
compute a series of at least one of Angle-of-Arrival (AoA) measurements and Frequency-Difference-of-Arrival (FDOA) over a period of time from antenna elements of the antenna aperture; and
invert the ECEF satellite location in conjunction with the series of the at least one AoA and FDOA measurements and using the series of the at least one AoA and FDOA measurements with STL raw observables as part of obtaining at least one of the geolocation position and velocity of the terminal.
